(19) United States
(12) Patent Application Publication
(10) Pub. No.: US 2004/0130973 A1
(43) Pub. Date: Jul. 8, 2004

(54) Presentation device and process for the visualization of a watchcase to be manufactured

(76) Inventor: Andre Hartje, Suligny-Sur-Frangy En Bresse (FR)

Correspondence Address: YOUNG & THOMPSON, 745 SOUTH 23RD STREET 2ND FLOOR, ARLINGTON, VA, 22202

(21) Appl. No.: 10/681,102

(22) Filed: Oct. 9, 2003

(30) Foreign Application Priority Data
Oct. 9, 2002 (EP) 02022606.4

(51) Int. Cl. A44C 5/00; G04B 37/00

(52) U.S. Cl. 368/281

(57) ABSTRACT

The presentation device comprises, as component parts, a basis member, such as plate (10), and several further members (12) constituted by rod-like parts (12a, 12b, 12c, 12d) adapted to be removably affixed to the plate (10). These rod-like parts are provided with grooves (24a, 24b) having a lateral opening (31) through which decorative pieces (25), such as gemstones, may be introduced. When the presentation device is assembled, it allows to obtain an exact visualization of the appearance of a watchcase with its gemstones.

The present invention relates to a presentation device and a process for the visualization of the appearance of a watchcase to be manufactured.

Precious watchcases are often provided with decorative pieces, such as cut precious stones or gemstones. These watchcases may be manufactured according to wishes of the purchaser. The decorative pieces and gemstones may be distributed and mounted for each purchaser in an individual manner. In order to plan this distribution, it is possible to establish a plurality of drawings showing the final decorated watchcase. However, it may be difficult for the purchaser to visualize the exact appearance of the final product on the basis of such drawings. Moreover, it is necessary for the manufacturer to establish a considerable number of drawings in order to give to the purchaser a reasonable choice of possibilities of colours and forms of the decorative pieces and gemstones.

It is the object of the present invention to provide a device or tool allowing an easy visualization of the appearance of the watchcase for the purchaser. It is in particular the object of the invention to allow the selling agents to show to the end purchaser of a high jewellery watch what the product he has chosen would look like as regards the precious stones.

These objects are realized by means of the features of claim 1.

According to these features, it is possible to elaborate and visualize the appearance that the watchcase with its decorative pieces, such as precious stones, may have. Also this appearance may easily be changed to take into account special wishes of the purchaser without complicated dismounting and mounting operations and without preparing drawings of the watchcase.

According to a preferred embodiment, the presentation device is characterized by the fact that said component parts comprise a basis member and at least two further members adapted to be removably positioned on the basis member in predetermined positions, said further members being provided with said maintaining portions configured in order to removably maintain exchangeable decorative pieces, the presentation device being adapted to show the general appearance of said watchcase when said further members are assembled to the basis member and provided with said decorative pieces.

By means of these features, the presentation device allows a very easy handling and a simple, solid and advantageous construction.

Favourably, the basis member is constituted by a plate and the further members are rod-like parts having the shape of the bezel of the watchcase when assembled on the plate and preferably said rod-like parts are adapted to be removably affixed to the plate near its periphery by means of positioning teats.

These features allow an excellent visualization of the appearance of the final watchcase, whilst having an uncomplicated construction and permitting easy handling.

In a preferred embodiment said further members are provided with grooves as maintaining parts adapted to maintain in a removable and interchangeable manner said decorative pieces.

Moreover said grooves may comprise bottom and lateral walls, an upper opening and parts provided on said lateral walls adapted to cooperate with a rim of the decorative pieces in order to maintain the latter in said grooves, which have at least a transversal opening when disassembled from said plate, said decorative pieces being adapted to be introduced into the grooves through said transversal opening.

The decorative pieces may by these features easily be mounted and interchanged, but are nevertheless completely maintained on the presentation device even if the latter is turned in all directions.

In a variant said presentation device further comprises at least a model of a dial and/or of hands adapted to be affixed to the basis member.

It is thus possible to complete the visualization tool in order to obtain an overall preview of the appearance of the watchcase.

The present invention relates also to a process for the visualization of the appearance of a watchcase to be manufacture comprising the steps of placing and fixing exchangeable decorative pieces on maintaining portions configured in order to removably maintain said decorative pieces and provided on component parts of a presentation device, removably assembling one to the other(s) said component parts in order to obtain said presentation device which is adapted to visualize the appearance of said watchcase provided with said decorative pieces.

By means of these process features, the appearance of the watchcase to be produced may be visualized for the purchaser in a very easy and precise manner, without preparing drawings of the watchcase.

Other advantages will become apparent from the features set forth in the dependent claims and the description setting forth the invention hereafter in more detail with the aid of drawings which represent schematically and by way of examples two embodiments.

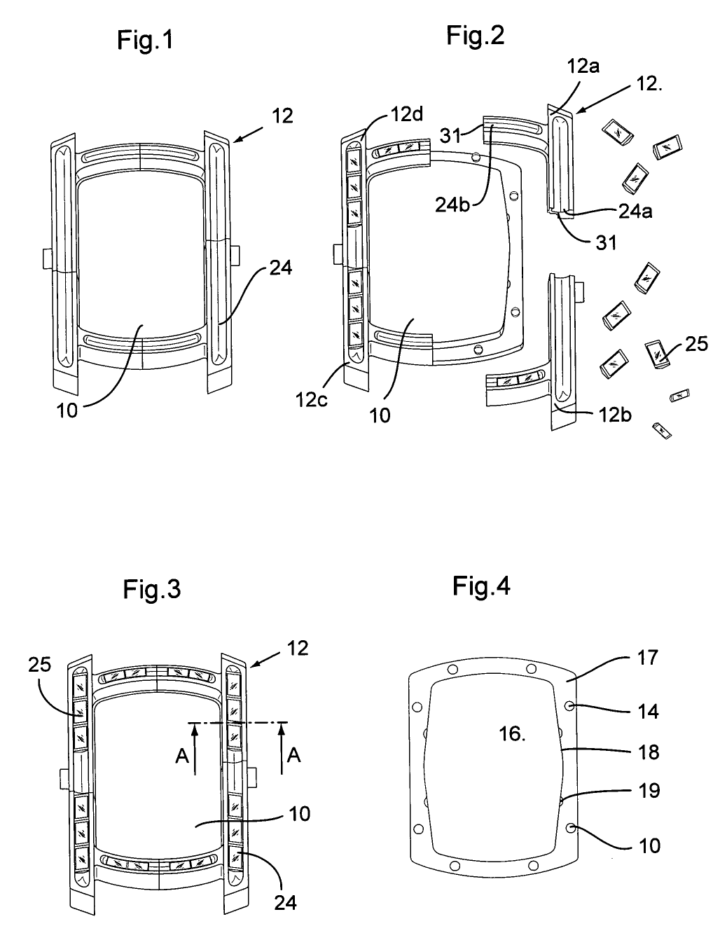

FIG. 1 is a top view of an embodiment of the assembled presentation device without gemstones.

FIG. 2 is a top view of said embodiment partially disassembled.

FIG. 3 is a top view of said embodiment assembled with gemstones.

FIG. 4 is a top view of the basis plate.

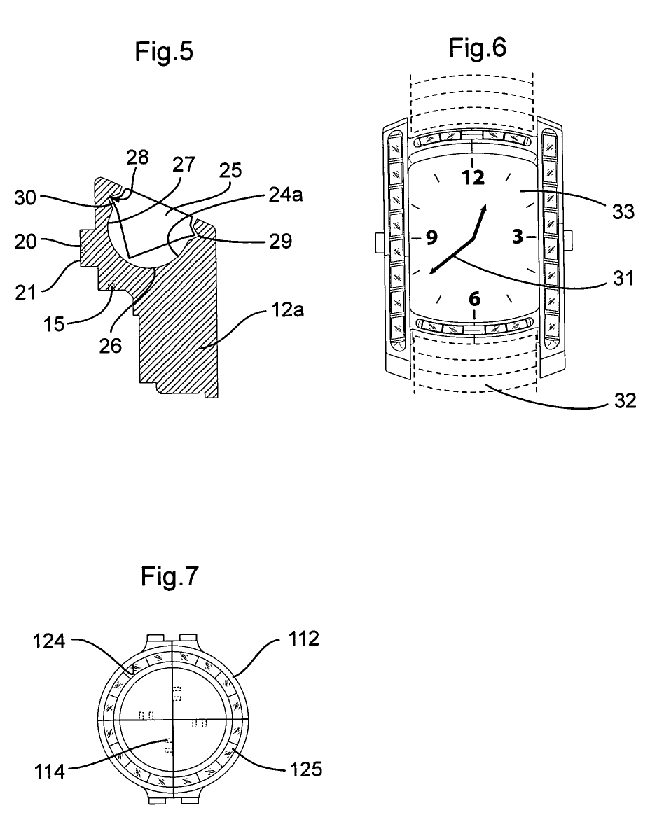

FIG. 5 is a partial cross-section according to line A-A of FIG. 3.

FIG. 6 is a top view of a further embodiment in an assembled state with a dial and hands.

FIG. 7 is a top view of a third embodiment.

The first embodiment of presentation device represented in FIGS. 1 to 5 is particularly adapted for the visualization of the appearance of a watchcase provided with decorative elements, such as gemstones. Thus, the sales agent of a watch can show to the end purchaser of a high jewellery watch what the product he has chosen would look like particularly as regards the gemstones.

The device comprises a basis member in the form of a plate 10 and a plurality of further members 12 adapted to be removably positioned on the basis plate 10. These further members are in the embodiment constituted by rod-like parts 12a, 12b, 12c, 12d having together the shape of the bezel of a watchcase when assembled on the plate 10. In this embodiment, the device comprises four rod-like parts 12a, 12b, 12c, 12d, but a different number may also be chosen.

These rod-like parts 12 are removably affixed to the plate 10 near its periphery by means of vertical positioning teats 14 provided on plate 10. The latter penetrate when assembled in holes 15 (FIG. 5) on the rod-like parts 12.

Moreover the plate 10 has an inner elevated part 16 separated from an outer lower part 17 by a vertical wall 18 (FIG. 4).

Small balls 19 are set in said vertical walls 18 and co-operate with hollows 20 provided on the vertical inner wall 21 of the rod-like parts 12, in order to removably maintain the latter on plate 10.

The rod-like parts 12 comprise maintaining portions 24 in the form of grooves 24a, 24b configured in order to removably maintain exchangeable decorative pieces 25, such as gemstones. These grooves may have different widths 24a, 24b for gemstones of different sizes.

As can be seen in FIG. 5 showing a groove of larger width, said groove 24a has a bottom wall 26, lateral walls 27 and an upper opening 28. Notches 29 provided on the lateral walls 27 are adapted to co-operate with rims 30 of the gemstones 25 in order to maintain them in the groove 24a.

When the rod-like parts 12 are removed from plate 10, its grooves 24a, 24b have a transversal opening 31 through which the gemstones 25 may be slidingly introduced.

The presentation device shown in FIG. 1 may be disassembled by removing the rod-like parts 12 from plate 10. In this state (FIG. 2) the decorative pieces and the gemstones 25 are introduced in the grooves 24 according to the wishes of the end purchaser and the rod-like parts 12 are then again mounted on plate 10 in order to obtain a visualization of the appearance of the desired watchcase. The rod-like parts 12 may be made of metals or alloys having different colours. Also the decorative pieces may be precious stones of any colour or any cut adapted to be positioned and maintained in an interchangeable manner in the grooves 24. The decorative pieces may also be metals of any type or other decorative or spacing pieces.

A further embodiment of the presentation device is represented in FIG. 6 and comprises at least a model of a dial 33 and/or of hands 31. The dial and the hands can be affixed in a removable and exchangeable manner on the device.

This embodiment allows a visualization of the overall appearance of the watch and watchcase, which may easily be adapted to the taste of the end purchaser. The presentation device can moreover be provided with exchangeable straps or bands 32.

According to the invention, one can visualize the appearance of a watchcase to be manufactured by a simple process or method comprising the steps of placing and fixing exchangeable decorative pieces 25, such as cut gemstones on maintaining portions 24 of component parts 12 of a presentation device. These maintaining portions may be grooves 24 with transversal openings 31 through which the gemstones 25 are slidingly introduced, these grooves being provided in rod-like parts 12a, 12b, 12c, 12d. The latter are then assembled on plate 10 in order to obtain the complete presentation device allowing to visualize the appearance of a watchcase to be produced with its decorative pieces and gemstones placed according to the wishes of the purchaser.

According to a further embodiment represented on FIG. 7, the presentation device may be constituted by at least two component parts, here the four components 112. The latter are constituted by four quarter pieces comprising each a groove 124 in which gemstones 125 may be slidingly introduced through transversal openings. The quarter pieces 112 are then assembled together by means of positioning teats 114 in order to constitute a presentation device adapted to show the general appearance of the watchcase provided with decorative pieces, such as gemstones.

The component parts may also be maintained together by other holding members, such as magnets.

Of course, the embodiments described above are in no way limiting and can be the subject of all desirable modifications within the framework defined by the independent claim.

The presentation device may be applied to any shape of watchcase, such as oval, round, rectangular, square watchcases. The component parts may have any shape and be constituted by plates or fretworks in any suitable material.

They may be of any shape suitable to represent the appearance of the watchcase. Their number may be different from four, but at least two.

The maintaining portions or grooves may be constituted by any means suitable to removably maintain the decorative pieces on the further members, for example by holes provided with an embedding and holding material.

The decorative pieces may be constituted by other materials than gemstones, such as precious metal pieces.

1. Presentation device for the visualization of the appearance of a watchcase to be manufactured comprising at least two component parts adapted to be removably assembled one to the other(s), said component parts comprising maintaining portions configured in order to removably maintain exchangeable decorative pieces, the presentation device being adapted to show the general appearance of said watchcase when said component parts are assembled and provided with said decorative pieces.

2. Presentation device according to claim 1, characterized by the fact that said component parts comprise a basis member and at least two further members adapted to be removably positioned on the basis member in predetermined positions, said further members being provided with said maintaining portions configured in order to removably maintain exchangeable decorative pieces, the presentation device being adapted to show the general appearance of said watchcase when said further members are assembled to the basis member and provided with said decorative pieces.

3. Presentation device according to claim 2, characterized by the fact that the basis member is constituted by a plate and the further members are rod-like parts having the shape of the bezel of the watchcase when assembled on the plate.

4. Presentation device according to claim 3, characterized by the fact that said rod-like parts are adapted to be removably affixed to the plate near its periphery by means of positioning teats.

5. Presentation device according to claim 2, characterized by the fact that said further members are provided with grooves as maintaining portions adapted to maintain in a removable and interchangeable manner said decorative pieces.

6. Presentation device according to claim 5, characterized by the fact that said grooves comprise bottom and lateral walls, an upper opening and parts provided on said lateral walls adapted to co-operate with a rim of the decorative pieces in order to maintain the latter in said grooves, which have at least a transversal opening when disassembled from said plate, said decorative pieces being adapted to be introduced into the grooves through said transversal opening.

7. Presentation device according to claim 5, characterized by the fact that said decorative pieces are precious stones cut in order to be positioned in an interchangeable manner in said grooves.

8. Presentation device according to claim 1, characterized by the fact that said component parts are made of metals or alloys of different colours.

9. Presentation device according to claim 1, characterized by the fact that it comprises at least a model of a dial and/or of hands adapted to be affixed to at least one of said component parts.

10. Process for the visualization of the appearance of a watchcase to be manufactured comprising the steps of placing and fixing exchangeable decorative pieces on maintaining portions configured in order to removably maintain said decorative pieces and provided on component parts of a presentation device, removably assembling one to the other(s) said component parts in order to obtain said presentation device which is adapted to visualize the appearance of said watchcase provided with said decorative pieces.

11. Process according to claim 10, characterized by removably assembling a basis member and at least two further members, said basis and further members constituting said component parts of the presentation device, and by placing and fixing first the decorative pieces on the maintaining portions provided on said further members.

12. Process according to claim 11, characterized by removably assembling a plate as basis member and rod-like parts as further members having the shape of the bezel of the watchcase when assembled on the plate.

13. Process according to claim 12, characterized by removably assembling the rod-like parts on the plate near its periphery by means of positioning teats.

14. Process according to one of the claim 11, characterized by introducing the decorative pieces through lateral openings in grooves forming said maintaining portions provided on said further members and adapted to maintain in a removable and interchangeable manner said decorative pieces.

15. Process according to claim 14, characterized by taking, as decorative pieces, precious stones cut in order to be positioned in an interchangeable manner in said grooves.

16. Process according to claim 10, characterized by affixing a model of a dial and/or hands to at least one of said component parts.
